(19) United States
(12) Patent Application Publication
(10) Pub. No.: US 2026/0292813 A1
(43) Pub. Date: Sep. 24, 2026

(54) ENHANCEMENTS ON MULTI-TRANSMISSION AND RECEPTION POINT TRANSMISSION

(71) Applicant: Nokia Technologies Oy, Espoo (FI)

(72) Inventors: Tao YANG, Shanghai (CN); Hao LIU, Shanghai (CN); Nuan SONG, Shanghai (CN); Yan ZHAO, Shanghai (CN)

(21) Appl. No.: 18/996,133

(22) PCT Filed: Jul. 28, 2022
(86) PCT No.: PCT/CN2022/108540

§ 371 Date: Jan. 17, 2025

(51) Int. Cl. H04W 72/1263; H04L 5/00

(52) U.S. Cl. CPC H04W 72/1263; H04L 5/0053

(57) ABSTRACT

A device, method, apparatus and computer readable storage media of enhancements on m-TRP transmission. The method includes receiving, at a first device and from a second device, a first indication of a target type of a multi-transmission and reception point, m-TRP, transmission to be scheduled in a target transmission occasion and a second indication of at least one TRP associated with the m-TRP transmission; and receiving the m-TRP transmission based at least in part on the first and second indications in the target transmission occasion. In this way, the UE and network are aligned with coherent joint transmission (CJT) and non-coherent joint transmission (NCJT) strategy and scheduling information, which ensures that the UE can accurately receive the m-TRP transmission.

### FIELD

Embodiments of the present disclosure generally relate to the field of telecommunication and in particular, to devices, methods, apparatus and computer readable storage media for enhancements to enable multi-transmission and reception point (m-TRP) transmission.

### BACKGROUND

With the evolution of Multiple Input Multiple Output (MIMO) technology, multi-transmission and reception point (m-TRP) transmission has been supported in the network, e.g., in a 5G network. Generally, the m-TRP transmission is scheduled based on a non-coherent joint transmission (NCJT) strategy. That is, two TRPs may transmit different data streams to a UE in a transmission occasion, and the data streams are scheduled by either a single downlink control information (S-DCI) or by multiple DCIs (M-DCI). For some target frequency ranges, such as FR1, the NCJT is expected to be implemented with up to 4 TRPs.

Furthermore, the network is also expected to support a m-TRP transmission scheduled based on a coherent joint transmission (CJT) strategy involving up to 4 TRPs. In the CJT, all the TRPs transmit the same data stream on the same radio resource. In this way, the signal to interference plus noise ratio (SINR) and the data decoding performance at UE side are improved.

### SUMMARY

In general, example embodiments of the present disclosure provide a solution of multi-transmission and reception point transmission.

In a first aspect, there is provided a first device. The first device comprises at least one processor; and at least one memory storing instructions that, when executed by the at least one processor, cause the first device at least to: receive, from a second device, a first indication of a target type of a multi-transmission and reception point, m-TRP, transmission to be scheduled in a target transmission occasion and a second indication of at least one TRP associated with the m-TRP transmission; and receive the m-TRP transmission based at least in part on the first and second indications in the target transmission occasion.

In a second aspect, there is provided a second device. The second device comprises at least one processor; and at least one memory storing instructions that, when executed by the at least one processor, cause the second device at least to: transmit, to a first device, a first indication of a target type of a multi-transmission and reception point, m-TRP, transmission to be scheduled in a target transmission occasion and a second indication of at least one TRP associated with the m-TRP transmission.

In a third aspect, there is provided a method. The method comprises: receiving, at a first device and from a second device, a first indication of a target type of a multi-transmission and reception point, m-TRP, transmission to be scheduled in a target transmission occasion and a second indication of at least one TRP associated with the m-TRP transmission; and receiving the m-TRP transmission based at least in part on the first and second indications in the target transmission occasion.

In a fourth aspect, there is provided a method. The method comprises: transmitting, at a second device and to a first device, a first indication of a target type of a multi-transmission and reception point, m-TRP, transmission to be scheduled in a target transmission occasion and a second indication of at least one TRP associated with the m-TRP transmission.

In a fifth aspect, there is provided a first apparatus. The first apparatus comprises: means for receiving, from a second apparatus, a first indication of a target type of a multi-transmission and reception point, m-TRP, transmission to be scheduled in a target transmission occasion and a second indication of at least one TRP associated with the m-TRP transmission; and means for receiving the m-TRP transmission based at least in part on the first and second indications in the target transmission occasion.

In a sixth aspect, there is provided a second apparatus. The second apparatus comprises: means for transmitting, to a first apparatus, a first indication of a target type of a multi-transmission and reception point, m-TRP, transmission to be scheduled in a target transmission occasion and a second indication of at least one TRP associated with the m-TRP transmission.

In a seventh aspect, there is provided a computer readable medium having a computer program stored thereon which, when executed by at least one processor of a device, causes the device to carry out the method according to the third aspect.

In an eighth aspect, there is provided a computer readable medium having a computer program stored thereon which, when executed by at least one processor of a device, causes the device to carry out the method according to the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example network system in which example embodiments of the present disclosure can be implemented;

FIG. 2 shows a signaling chart illustrating an example m-TRP transmission procedure according to some example embodiments of the present disclosure;

FIG. 3 illustrates a schematic diagram of an example medium access control (MAC) control element (CE) for m-TRP transmission information according to some example embodiments of the present disclosure;

FIG. 4 illustrates a schematic diagram of another example MAC CE for m-TRP transmission information according to some example embodiments of the present disclosure;

FIG. 5 illustrates a flowchart of an example method according to some example embodiments of the present disclosure;

FIG. 6 illustrates a flowchart of another example method according to some example embodiments of the present disclosure;

FIG. 7 shows a simplified block diagram of a device that is suitable for implementing example embodiments of the present disclosure; and

FIG. 8 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

In the communication network, the m-TRP transmission based on the NCJT strategy is supported with 2 TRPs. With the development of m-TRP transmission, up to 4 TRPs are expected to be used for supporting both NCJT and CJT. To this end, the network should clearly indicate whether CJT or NCJT strategy is to be adopted for the DL data transmission and reception in some future m-TRP transmission occasions.

In CJT strategy, all the involved TRPs transmit the same data stream (e.g., physical downlink shared channel (PDSCH) data stream) on the same radio resources. Since there is no need to differentiate the data streams, the UE does not need to know from which TRP each PDSCH data stream for CJT is received. In view of this, the CJT may be considered as transparent to the UE. However, before receiving the PDSCH data streams for CJT, UE has to clearly understand these data streams are to be transmitted on which radio resources. Considering that in CJT, data streams from multiple TRPs use the same radio resources, it is straightforward that one TRP is necessary to transmit a corresponding physical downlink control channel (PDCCH) to the UE. That is, only S-DCI is adopted for m-TRP transmission based on CJT strategy.

In NCJT strategy, the involved TRPs may transmit different data streams to UE on same or different radio resources. As previously mentioned, the m-TRP transmission based on the NCJT strategy may be scheduled via either S-DCI or M-DCI. Since UE should differentiate the radio links between UE and all the involved TRPs, UE needs to be clearly indicated: i) from which one or more TRP to receive the DCI for the m-TRP transmission based on NCJT strategy; and ii) from which TRPs to receive the PDSCH data streams.

In order to solve the above and other potential problems, embodiments of the present disclosure provide an efficient configurable m-TRP transmission mechanism. In the proposed mechanism, DL signaling of m-TRP information that is necessary for enabling the m-TRP transmission provided. As such, the m-TRP information is aligned at the base station and the UE. With the DL signaling, the base station can inform UE of whether the CJT or NCJT strategy is to be adopted in some subsequent transmission occasions. For both strategies, the base station indicates from which TRP(s) to receive the PDCCH(s) for the coming data transmission. Furthermore, for NCJT, the base station informs UE of which TRP(s) will be involved for the following or some subsequent PDSCH transmission. As a result, the CJT and NCJT transmission will be supported, and the UE's performance will be improved.

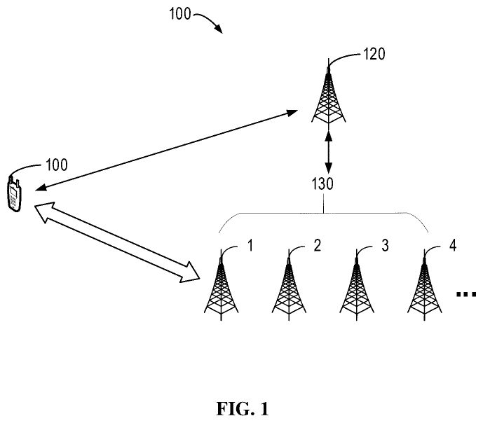

FIG. 1 illustrates an example network system 100 in which example embodiments of the present disclosure can be implemented. As shown in FIG. 1, the communication network 100 may include a first device 110, a second device 120, and TRPs 1 to 4. The first device 110 may be a terminal device (e.g., UE). The second device 120 and the TRPs 1 to 4 may be network devices (e.g., gNBs) that serve the first device 110.

The network system 100 is a MIMO system where the second device 120 and the TRPs 1 to 4 may communicate with first device 110 based on either CJT or NCJT strategy.

In CJT strategy, a part or all of TRPs 1 to 4 may transmit the same data transmissions on the same radio resources (e.g., on PDSCH) in a transmission occasion. Such CJT transmissions may be scheduled via DCI from one of the TRPs 1 to 4.

In NCJT strategy, a part or all of TRPs 1 to 4 may transmit different data transmissions on the same or different radio resources (e.g., on PDSCH) in a transmission occasion. As discussed above, the NCJT transmission may be scheduled via S-DCI from one of the TRPs 1 to 4, or alternatively, via M-DCI from a plurality of the TRPs 1 to 4.

In the context of the present disclosure, such data transmissions may be also referred to as m-TRP transmission. The one or more of TRPs 1 to 4 that transmits corresponding DCI(s) for the m-TRP transmission may be also referred to as target TRP(s). Additionally, the part or all of TRPs 1 to 4 involved in the m-TRP transmission may be collectively referred to as a serving cluster of the first device 110.

To enable the CJT and NCJT strategies, the second device 120 may provide necessary information about the m-TRP transmission to be scheduled in some subsequent transmission occasions. Such information may indicate at least one of the following:
a target type of the m-TRP transmission, for example, either the CJT or the NCJT transmission is to be scheduled,
in case of the CJT transmission to be scheduled, which TRP is to transmit the DCI for the m-TRP transmission,
in case of the NCJT transmission to be scheduled, either S-DCI or M-DCI and the corresponding TRP(s) are to be adopted for NCJT transmission, which TRP(s) is (are) to transmit the m-TRP transmissions, and so on.

In the context of the present disclosure, the target type of the m-TRP transmission includes, but not limited to, a m-TRP transmission based on the CJT strategy (which may be also referred to as a CJT transmission), a m-TRP transmission based on the NCJT strategy (which may be also referred to as a NCJT transmission), or any other transmission involving multiple TRPs based on either existing strategy or a future strategy.

In some example embodiments, such information is included in a MAC CE, which may be a MAC CE dedicated to m-TRP transmission, or a MAC CE for transmission configuration indicator (TCI) state activation/de-activation.

Although the second device 120 is illustrated as separate from the TRP 1 to 4, in some other embodiments, the second device 120 may be one of the TRP 1 to 4. In other words, the network device that provides the m-TRP information may or may not be one of the TRPs that transmit the m-TRP transmission.

It is to be understood that the number of the terminal device, the network device, the TRPs, etc. shown in FIG. 1 is given for the purpose of illustration without suggesting any limitations. In practice, the communication network 100 may include any suitable number of terminal devices, network devices, TRPs and so on.

Depending on the communication technologies, the communication network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

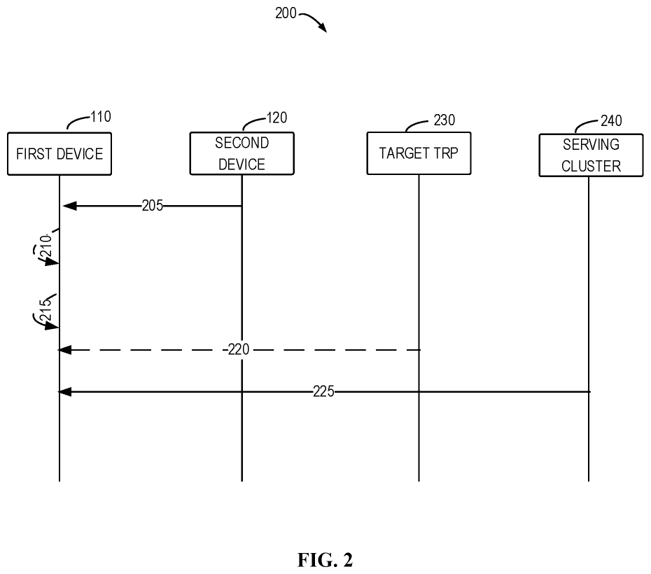

Principle and implementations of the present disclosure will be described in detail below with reference to FIGS. 2 to 6. FIG. 2 shows a signaling chart illustrating an example m-TRP transmission procedure 200 according to some example embodiments of the present disclosure. The process 200 may involve the first device 110, the second device 120 and the TRPs 1 to 4 as shown in FIG. 1. For discussion, the process 200 will be described with reference to FIG. 1.

In the process 200, the first device 110 is served by at least a part of the TRP 1 to 4. In particular, the first device 110 may receive m-TRP transmissions from at least a part of the TRPs 1 to 4 based on either CJT or NCJT strategy. In the following description, at least one of the TRPs 1 to 4 that transmits DCI for the m-TRP transmissions may be referred to as target TRP(s) 230, and the part or all of the TRPs 1 to 4 that transmit the m-TRP transmissions may be collectively referred to as serving cluster 240.

It should be understood that, in some embodiments, the target TRP 230 may be one of the serving cluster 240, while in some other embodiments, the target TRP 230 may be separate from the serving cluster 240.

The second device 120 transmits 205, to the first device 110, a first indication of a target type of a m-TRP transmission to be scheduled in a target transmission occasion and a second indication of at least one TRP associated with the m-TRP transmission. For example, the target type may be one of the CJT or the NCJT. Additionally, the first device 110 may determine how to understand the second indication based on a value of the first indication.

In some example embodiments, the first device 110 may determine 210 a target TRP 230 based on a value of the second indication. Additionally, or alternatively, in some example embodiments, a third indication may be transmitted to the first device 110. Accordingly, the first device 110 may determine 215 the serving cluster 240 based on a value of the third indication. In some example embodiments, the first device 110 may receive 220 DCI from the target TRP 230.

In some example embodiments, the first indication and the second indication may be included in a MAC CE dedicated to the m-TRP transmission. For example, a layer 2 MAC CE may be designed for aligning the m-TRP information (e.g., the first and second indications) between the first device 110 and the second device 120.

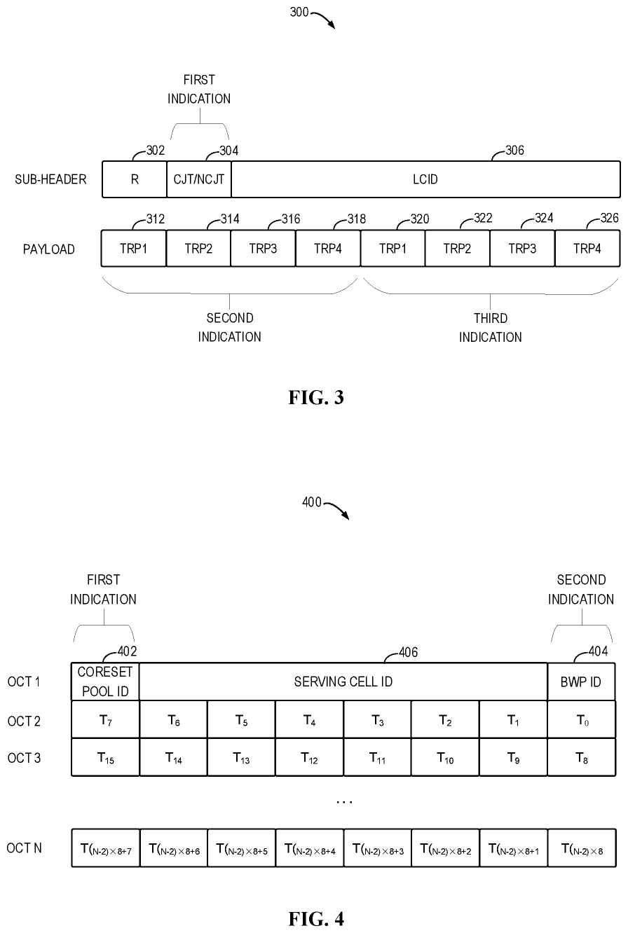

FIG. 3 illustrates a schematic diagram of an example MAC CE 300 for m-TRP transmission information according to some example embodiments of the present disclosure. As shown in FIG. 3, the MAC CE 300 consists of two bytes, where a first byte is the MAC CE sub-header, and a second byte is the MAC CE payload. In particular, the MAC CE sub-header consists of three parts, i.e., a R bit 302 reserved for other use, a CJT/NCJT indication 304 and a logical channel identity (LCID) filed 306. By way of example, the R 302 bit may be 1 bit, the CJT/NCJT indication 304 may be 1 bit, and the LCID field 306 may be 6 bits.

The CJT/NCJT indication 304 may be used for the first indication and indicate a following or some subsequent m-TRP transmission to be scheduled based on the CJT strategy or the NCJT strategy. By way of example, a first value (e.g., 1) of the CJT/NCJT indication 304 may indicate the CJT transmission, while a second value (e.g., 0) of the CJT/NCJT indication 304 may indicate the NCJT transmission, or vice vera. The LCID field may indicate that this MAC CE is specific to providing m-TRP information. To this end, a dedicated LCID may be assigned to differentiate this new MAC CE.

Additionally, the first device 110 may determine how to understand the payload part based on a value of the CJT/NCJT indication. In some example embodiments, the MAC CE payload may include a PDCCH indication and a PDSCH indication. The PDCCH indication may be used for the second indication and include 4 bits 312 to 318, each mapping to a corresponding one of TRPs 1 to 4.

In particular, the PDCCH indication may indicate the target TRP 230, that is, from which one or more of the TRPs 1 to 4 to receive DCI for the m-TRP transmission. In case of the CJT transmission to be scheduled, the PDCCH indication may indicate only one TRP transmitting the DCI.

In case of the NCJT transmission to be scheduled, the 4 bits in PDCCH indication may implicitly indicate the first device 110 of either S-DCI or M-DCI is to be adopted and the corresponding one or more TRPs transmitting the DCI. If only one TRP is indicated in the PDCCH indication, the first device 110 may determine that the m-TRP transmission is scheduled based on S-DCI scheme, and the indicated TRP is the target TRP 230 that transmits the S-DCI. If more than one TRP is indicated in the PDCCH indication, the first device 110 may determine that the m-TRP transmission is scheduled based on M-DCI scheme, and the first device 110 may try to receive DCIs from these indicated TRPs respectively.

The PDSCH indication may be used for a third indication and include 4 bits 320 to 326 each mapping to a corresponding one of TRPs 1 to 4. In a case where the coming m-TRP transmission is the CJT transmission, the first device 110 may ignore the PDSCH indication. This is because the first device 110 has no need to know which TRPs to transmit the CJT transmission. Thus, in this case, the 4-bits in PDSCH indication may be reserved for future use. In a case where the coming m-TRP transmission is the NCJT transmission, the 4-bit PDSCH indication is set to indicate from which TRPs to receive the NCJT transmission.

The number of bits in the PDCCH indication and PDSCH indication may correspond to the number of TRPs in the serving cluster 240, with one bit for one TRP. In some example embodiments, 4 bits in each of the PDCCH and PDSCH fields may be in an order based on the TRP ID or any other pre-defined principle. In this way, the first device 110 and the second device 120 are aligned on the mapping between the bits in PDCCH indication and PDSCH indication and the four TRPs configured for m-TRP transmission. Of course, in a case where less than four TRPs are involved in the serving cluster 240, the first device 110 may only need to decode part of the 4-bit fields and ignore the remaining bit.

Additionally, or alternatively, in some example embodiments, the first indication and the second indication may be included in a MAC CE of transmission configuration indicator (TCI) states activation/deactivation. In other words, the existing MAC CE may be reused for indicating the m-TRP information.

The MAC CE of TCI state activation/deactivation may be used for m-TRP transmission, because it is capable of indicating the TCI states of multiple serving cells. Here multiple serving cells may refer to the multiple serving TRPs. When the MAC CE is used for multiple serving cell or multiple TRPs situation, two information elements (IEs) are kept as unused, that is, CORESET Pool ID and bandwidth part (BWP) ID. Therefore, when this MAC CE is reused for m-TRP situation, these two IEs may be considered for other use.

FIG. 4 illustrates a schematic diagram of another example MAC CE 400 for m-TRP transmission information according to some example embodiments of the present disclosure. As shown in FIG. 4, the MAC CE 400 may consist of N Octs, where the Oct 1 includes a 1-bit CORESET Pool ID 402, a 2-bit BWP ID 404 and a field of serving cell ID 406, and Octs 2 to N indicate TCI states of multiple serving cells.

The CORESET Pool ID 402 may be used for the first indication that indicates a following or some subsequent m-TRP transmission to be scheduled based on the CJT strategy or the NCJT strategy. By way of example, a first value (e.g., 1) of CORESET Pool ID 402 may indicate the CJT transmission, while a second value (e.g., 0) of CORESET Pool ID 402 may indicate the NCJT transmission, or vice vera.

Additionally, the first device 110 may determine how to understand the BWP ID 404 based on a value of the CORESET Pool ID 402. In some example embodiments, if the value of the CORESET Pool ID 402 indicates the CJT transmission to be scheduled, the BWP ID 404 may indicate the target TRP 230, i.e., from which TRP to receive the DCI for the CJT transmission. Example coding scheme of BWP ID is shown in Table 1 below.

TABLE 1
Example coding scheme of BWP ID

| BWP ID | TRP 1 | TRP 2 | TRP 3 | TRP 4 |
|---|---|---|---|---|
| 00 | ✓ | | | |
| 01 | | ✓ | | |
| 10 | | | ✓ | |
| 11 | | | | ✓ |

In the example of table 1, a value “00” of BWP ID 404 indicates TRP 1 to transmit the DCI for CJT transmission, a value “01” of BWP ID 404 indicates TRP 2 to transmit the DCI for CJT transmission, a value “10” of BWP ID 404 indicates TRP 3 to transmit the DCI for CJT transmission, and a value “11” of BWP ID 404 indicates TRP 4 to transmit the DCI for CJT transmission. In this case, the first device 110 may only try to receive the PDCCH transmission from the indicated TRP and will not check PDCCH from other TRPs.

In some example embodiments, if the value of the CORESET Pool ID 402 indicates the NCJT transmission to be scheduled, the BWP ID 404 may indicate from which TRPs to receive the NCJT transmissions. Additionally, in this case, whether S-DCI or M-DCI is to be adopted for the NCJT transmission may be indicated via an RRC message. Example coding scheme of BWP ID is shown in Table 2 below.

TABLE 2
Example coding scheme of BWP ID

| BWP ID | TRP 1 | TRP 2 | TRP 3 | TRP 4 |
|---|---|---|---|---|
| 00 | ✓ | X | X | X |
| 01 | ✓ | ✓ | X | X |
| 10 | ✓ | ✓ | ✓ | X |
| 11 | ✓ | ✓ | ✓ | ✓ |

In the example of table 2, a value “00” of BWP ID 404 indicates the first TRP of the serving cluster 240 (i.e., TRP 1) to transmit the NCJT transmission, a value “01” of BWP ID 404 indicates the first two TRP of the serving cluster 240 (i.e., TRP 1 and TRP 2) to transmit NCJT transmissions, a value “10” of BWP ID 404 indicates the first three TRPs of the serving cluster 240 (i.e., TRP 1, TRP 2 and TRP 3) to transmit the NCJT transmissions, and a value “11” of BWP ID 404 indicates all the TRPs of the serving cluster 240 to transmit the NCJT transmissions.

Additionally, or alternatively, in the example of table 2, the four TRPs 1 to 4 are sequenced according to a predefined rule. By way of example, according to the predefined rule, the TRPs 1 to 4 may be sequenced based on a descending order of large scale information for the TRPs 1 to 4. In this case, the second device 120 may always schedule the TRP with higher large scale information for DL transmission. Thus, 2 bits are enough to indicate four situations. For example, if the second device 120 schedules one TRP to serve the first device 110, which is indicated by BWP ID=00, the first device 110 may be aware that TRP 1 with the highest large scale situation will be scheduled. If the second device 120 schedules three TRPs to serve the first device 110, which is indicated by BWP ID=10, the first device 110 may be aware that TRP 1, TRP 2 and TRP 3 will be selected for the NCJT transmission.

In a case where the second device 120 expects to schedule TRP 1, TRP 3 and TRP 4 to serve the first device 110, the second device 120 may schedule TRP 1, TRP 2, TRP 3 and TRP 4 to serve the first device 110, which covers the second device 120's original intention of scheduling TRP 1, TRP 3 and TRP 4.

It should be understood that the values of BWP ID in table 1 and table 2 are given for illustrative purpose, and any other values are also be possible for implementations of the present disclosure.

Referring back to FIG. 2, the first device 110 receives 225 the m-TRP transmission based at least in part on the first and second indications in the target transmission occasion.

It should be understood that some of the steps in process 200 is optional or can be omitted, and the order of the steps is given for an illustrative purpose. For example, step 215 may be omitted in case of CJT transmission. Thus, the embodiments of the present disclosure are not limited in this regard.

According to the example embodiments of the present disclosure, the m-TRP information for enabling the CJT transmission and NCJT transmission is aligned at the UE side and the network side. As such, the UE can properly receive the m-TRP transmission, and the network performance can be improved.

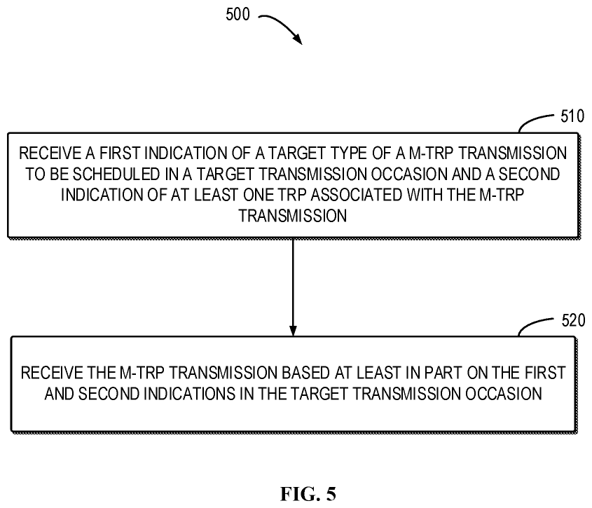

FIG. 5 illustrates a flowchart of an example method 500 according to some example embodiments of the present disclosure. The method 500 can be implemented at a terminal device, for example, the first device 110 described with reference to FIG. 1. For the purpose of discussion, the method 500 will be described with reference to FIG. 1.

At 510, the first device 110 receives from a second device 120 a first indication of a target type of a m-TRP transmission to be scheduled in a target transmission occasion and a second indication of at least one TRP associated with the m-TRP transmission. The target type of the m-TRP transmission may include one of a CJT or a NCJT type of m-TRP transmission.

At 520, the first device 110 receive the m-TRP transmission based at least in part on the first and second indications in the target transmission occasion.

In some example embodiments, the first device 110 may receive, from the at least one TRP as indicated by the second indication, the m-TRP transmission according to the target type as indicated by the first indication.

In some example embodiments, the first indication may be included in a sub-header of a MAC CE for m-TRP transmission, and the sub-header of the MAC CE may further comprise a LCID corresponding to the m-TRP transmission. Additionally, the second indication may be included in a payload of the MAC CE and indicates at least one first TRP transmitting at least one DCI for the m-TRP transmission. For example, a layer 2 MAC CE may be designed to carry the first and second indications for the m-TRP transmission.

In some example embodiments, a value of the first indication may indicate whether the target type is CJT or NCJT. If the first indication is set to a first value indicative of the CJT, the first device 110 may determine a first TRP based on a value of the second indication. The first device 110 may receive, from the first TRP, DCI for the CJT. Accordingly, the first device 110 may then receive, based on the DCI and from a group of second TRPs, a plurality of data transmissions corresponding to the CJT. In the context of the present disclosure, the term “first TRP” may refer to the TRP(s) transmitting DCI for m-TRP transmission, and the term “a group of second TRPs” may refer to the TRPs of the serving cluster and transmitting the m-TRP transmission.

In some example embodiments, the payload of the MAC CE may further comprise a third indication of a group of second TRPs transmitting the m-TRP transmission. In these embodiments, if the first indication is set to a second value indicative of the NCJT, the first device 110 may determine the at least one first TRP based on a value of the second indication and the group of second TRPs based on a value of the third indication. The first device 110 may then receive, from the at least one first TRP, at least one DCI for the NCJT. Accordingly, the first device 110 may receive, based on the at least one DCI and from the group of second TRPs, a plurality of data transmissions corresponding to the NCJT.

In some example embodiments, the value of the second indication may implicitly indicate either S-DCI or M-DCI is to be adopted. In particular, if the value of the second indication indicates a single first TRP, the first device 110 may determine the m-TRP transmission to be scheduled by a single DCI. Otherwise, if the value of the second indication indicates a plurality of first TRPs, the first device 110 may determine the m-TRP transmission to be scheduled by multiple DCIs.

In some example embodiments, the first indication may be included in a field for a CORESET pool identity of a MAC CE for TCI state, and the second indication may be included in a field of a bandwidth part identity of the MAC CE. For example, the MAC CE of TCI state Activation/Deactivation CE may be reused for the first and second indications. By reusing the existing MAC CE for indicating the m-TRP information (e.g., the first and second indications), the DL signaling overhead can be reduced.

In some example embodiments where the first and second indications are included in the MAC CE for TCI state, if the first indication is set to a first value indicative of the CJT, the first device 110 may determine a first TRP transmitting DCI for the CJT based on a value of the second indication. The first device 110 may then receiving the DCI from the first TRP. Accordingly, the first device 110 may receive, based on the DCI and from a group of second TRPs, a plurality of data transmissions corresponding to the CJT.

Alternatively, or additionally, in some example embodiments, if the first indication is set to a second value indicative of the NCJT, the first device 110 may determine at least one of a group of second TRPs transmitting the m-TRP transmission based on a value of the second indication. The first device 110 may receive, from the second device 120, a RRC message indicating at least one first TRP transmitting at least one DCI for the NCJT. The first device 110 may then receive the at least one DCI from the at least one first TRP. Accordingly, the first device 110 may receive, based on the at least one DCI and from the at least one of the group of second TRPs, a plurality of data transmissions corresponding to the NCJT.

In some example embodiments, the RRC message may indicate the NCJT to be scheduled by a single DCI or multiple DCIs.

In some example embodiments, the field of the bandwidth part identity comprises 2 bits, and a first value of the bandwidth part identity indicates the first one of the group of second TRPs transmitting the m-TRP transmission, a second value of the bandwidth part identity indicates the first two of the group of second TRPs transmitting the m-TRP transmission, a third value of the bandwidth part identity indicates the first three of the group of second TRPs transmitting the m-TRP transmission, a fourth value of the bandwidth part identity indicates the group of second TRPs transmitting the m-TRP transmission, and an order of the group of second TRPs is based on a predefined rule associated with for the group of second TRPs.

In some example embodiments, the first device 110 and the second device 120 may be aware of the predefined rule. By way of example, according to the predefined rule, the order of the group of second TRPs may be determined based on a descending order of large scale information for the group of second TRPs.

In some example embodiments, the first device 110 may comprise a terminal device, and the second device 120 may comprise a network device.

According to the example embodiments, a m-TRP transmission mechanism is provided. In the mechanism, the CJT/NCJT strategy as well as m-TRP information are aligned at UE and the base station side. In this way, the UE can properly receive the m-TRP transmission, and the network performance can be improved.

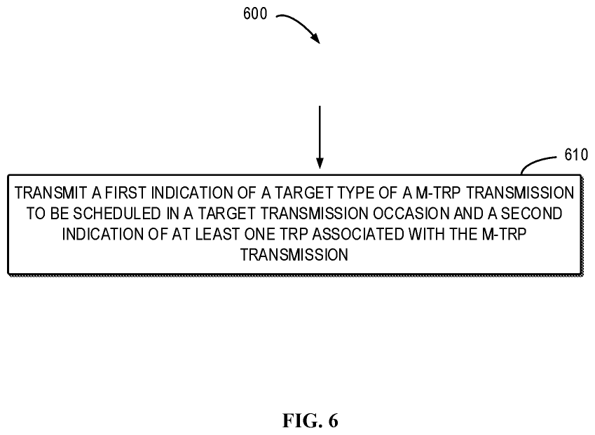

FIG. 6 illustrates a flowchart of an example method 600 according to some example embodiments of the present disclosure. The method 600 can be implemented at a network, for example, the second device 120 described with reference to FIG. 1. For the purpose of discussion, the method 600 will be described with reference to FIG. 1.

At 610, the second device 120 transmits, to a first device 110, a first indication of a target type of a m-TRP transmission to be scheduled in a target transmission occasion and a second indication of at least one TRP associated with the m-TRP transmission.

In some example embodiments, the first indication may be included in a sub-header of a MAC CE for m-TRP transmission, and the sub-header of the MAC CE may further comprise a LCID corresponding to the m-TRP transmission. Additionally, the second indication may be included in a payload of the MAC CE. For example, a layer 2 MAC CE may be designed to carry the first and second indications for the m-TRP transmission.

In some example embodiments, if the target type is a CJT setting, the second device 120 may set the first indication to a first value indicative of the CJT. The second device 120 may set the second indication to a value indicative of a first TRP transmitting DCI for the m-TRP transmission. Accordingly, the second device 120 may transmit the MAC CE comprising the first indication and the second indication to the first device 110.

In some example embodiments, the payload of the MAC CE may further comprise a third indication. If the target type is a NCJT, the second device 120 may set the first indication to a second value indicative of the NCJT. The second device 120 may set the second indication to a value indicative of at least one first TRP transmitting at least one DCI for the m-TRP transmission. The second device 120 may set the third indication to a value indicative of a group of second TRPs transmitting the m-TRP transmission. Accordingly, the second device 120 may transmit the MAC CE comprising the first indication, the second indication and the third indication to the first device 110.

In some example embodiments, the first indication may be included in a field for a CORESET pool identity of a MAC CE for TCI state, and the second indication may be included in a field of a bandwidth part identity of the MAC CE. For example, the MAC CE of TCI state Activation/Deactivation CE may be reused for the first and second indications. By reusing the existing MAC CE for indicating the m-TRP information (e.g., the first and second indications), the DL signaling overhead can be reduced.

In some example embodiments, if the target type is a CJT, the second device 120 may set the first indication to a first value indicative of the CJT. The second device 120 may set the second indication to a value indicative of a first TRP transmitting DCI for the m-TRP transmission. Accordingly, the second device 120 may transmit the MAC CE for TCI state comprising the first indication and the second indication to the first device 110.

Additionally, or alternatively, in some example embodiments, if the target type is a NCJT, the second device 120 may set the first indication to a second value indicative of the NCJT. The second device 120 may set the second indication to a value indicative of a group of second TRPs transmitting the m-TRP transmission. Accordingly, the second device 120 may transmit the MAC CE for TCI state comprising the first indication and the second indication to the first device 110.

In some example embodiments, the second device 120 may transmit, to the first device 110, a RRC message indicating at least one first TRP transmitting at least one DCI for the NCJT.

In some example embodiments, the field of the bandwidth part identity comprises 2 bits, and a first value of the bandwidth part identity indicates the first one of the group of second TRPs transmitting the m-TRP transmission, a second value of the bandwidth part identity indicates the first two of the group of second TRPs transmitting the m-TRP transmission, a third value of the bandwidth part identity indicates the first three of the group of second TRPs transmitting the m-TRP transmission, a fourth value of the bandwidth part identity indicates the group of second TRPs transmitting the m-TRP transmission, and an order of the group of second TRPs is based on a predefined rule associated with the group of second TRPs.

In some example embodiments, the first device 110 and the second device 120 may be aware of the predefined rule. By way of example, according to the predefined rule, the order of the group of second TRPs may be determined based on a descending order of large scale information for the group of second TRPs.

In some example embodiments, the first device 110 may comprise a terminal device, and the second device 120 may comprise a network device.

According to the embodiments of the present disclosure, the base station is enabled to indicate whether the CJT strategy or the NCJT strategy is to be adopted for the m-TRP transmission via an enhanced DL signaling. Furthermore, the base station can inform the UE of from which TRP to receive DCI for CJT/NCJT transmissions. For NCJT, the base station can further inform of from which one or more TRP to receive the NCJT transmissions. In this way, the m-TRP information is aligned at the UE and network side. Therefore, the network performance can be improved.

In some example embodiments, a first apparatus capable of performing the method 500 (for example, the first device 110) may comprise means for performing the respective steps of the method 500. The means may be implemented in any suitable form. For example, the means may be implemented in a circuitry or software module. In some embodiments, the means may comprise at least one processor and at least one memory including computer program code. The at least one memory and computer program code are configured to, with the at least one processor, cause performance of the first apparatus.

In some example embodiments, the first apparatus comprises: means for receiving, from a second apparatus, a first indication of a target type of a multi-transmission and reception point, m-TRP, transmission to be scheduled in a target transmission occasion and a second indication of at least one TRP associated with the m-TRP transmission; and means for receiving the m-TRP transmission based at least in part on the first and second indications in the target transmission occasion.

In some example embodiments, the means for receiving the multi-transmission and reception point transmission comprises: means for receiving, from the at least one multi-transmission and reception point as indicated by the second indication, the multi-transmission and reception point transmission according to the target type as indicated by the first indication.

In some example embodiments, the first indication is included in a sub-header of a medium access control control element for multi-transmission and reception point transmission, and the sub-header of the medium access control control element further comprises a logical channel identity corresponding to the multi-transmission and reception point transmission, and wherein the second indication is included in a payload of the medium access control control element and indicates at least one first transmission and reception point transmitting at least one downlink control information for the multi-transmission and reception point transmission.

In some example embodiments, the means for receiving the multi-transmission and reception point transmission comprises: means for in accordance with a determination that the first indication is set to a first value indicative of a coherent joint transmission determining a first transmission and reception point based on a value of the second indication; means for receiving, from the first transmission and reception point, downlink control information for the coherent joint transmission; and means for receiving, based on the downlink control information and from a group of second transmission and reception points, a plurality of data transmissions corresponding to the coherent joint transmission.

In some example embodiments, the payload of the medium access control control element further comprises a third indication of a group of second transmission and reception points transmitting the multi-transmission and reception point transmission. The means for receiving the multi-transmission and reception point transmission comprises: means for in accordance with a determination that the first indication is set to a second value indicative of a non-coherent joint transmission, determining the at least one first transmission and reception point based on a value of the second indication and the group of second transmission and reception points based on a value of the third indication; means for receiving, from the at least one first transmission and reception point, at least one downlink control information for the non-coherent joint transmission; and means for receiving, based on the at least one downlink control information and from the group of second transmission and reception points, a plurality of data transmissions corresponding to the non-coherent joint transmission.

In some example embodiments, the first apparatus further comprises: means for in accordance with a determination that the value of the second indication indicates a single first transmission and reception point, determining the multi-transmission and reception point transmission to be scheduled by a single downlink control information; and means for in accordance with a determination that the value of the second indication indicates a plurality of first transmission and reception points, determining the multi-transmission and reception point transmission to be scheduled by multiple downlink control information.

In some example embodiments, the first indication is included in a field for a CORESET pool identity of a medium access control control element for transmission configuration indicator state, and the second indication is included in a field of a bandwidth part identity of the medium access control control element.

In some example embodiments, the means for receiving the multi-transmission and reception point transmission comprises: means for in accordance with a determination that the first indication is set to a first value indicative of the coherent joint transmission, determining a first transmission and reception point transmitting downlink control information for the coherent joint transmission based on a value of the second indication; means for receiving the downlink control information from the first transmission and reception point; and means for receiving, based on the downlink control information and from a group of second transmission and reception points, a plurality of data transmissions corresponding to the coherent joint transmission.

In some example embodiments, the means for receiving the multi-transmission and reception point transmission comprises: means for in accordance with a determination that the first indication is set to a second value indicative of the non-coherent joint transmission, determining at least one of a group of second transmission and reception points transmitting the multi-transmission and reception point transmission based on a value of the second indication; means for receiving, from the second apparatus, a radio resource control message indicating at least one first transmission and reception point transmitting at least one downlink control information for the non-coherent joint transmission; means for receiving the at least one downlink control information from the at least one first transmission and reception point; and means for receiving, based on the at least one downlink control information and from the at least one of the group of second transmission and reception points, a plurality of data transmissions corresponding to the non-coherent joint transmission.

In some example embodiments, the radio resource control message indicates the non-coherent joint transmission to be scheduled by a single downlink control information or multiple downlink control information.

In some example embodiments, the field of the bandwidth part identity comprises 2 bits, and a first value of the bandwidth part identity indicates the first one of the group of second transmission and reception points transmitting the multi-transmission and reception point transmission, a second value of the bandwidth part identity indicates the first two of the group of second transmission and reception points transmitting the multi-transmission and reception point transmission, a third value of the bandwidth part identity indicates the first three of the group of second transmission and reception points transmitting the multi-transmission and reception point transmission, a fourth value of the bandwidth part identity indicates the group of second transmission and reception points transmitting the multi-transmission and reception point transmission, and an order of the group of second transmission and reception points is based on a predefined rule associated with the group of second transmission and reception points.

In some example embodiments, the first apparatus comprises a terminal device, and the second apparatus comprises a network device.

In some example embodiments, a second apparatus capable of performing the method 600 (for example, the second device 120) may comprise means for performing the respective steps of the method 600. The means may be implemented in any suitable form. For example, the means may be implemented in a circuitry or software module. In some embodiments, the means may comprise at least one processor and at least one memory including computer program code. The at least one memory and computer program code are configured to, with the at least one processor, cause performance of the second apparatus.

In some example embodiments, the second apparatus comprises: means for transmitting, to a first apparatus, a first indication of a target type of a multi-transmission and reception point, m-TRP, transmission to be scheduled in a target transmission occasion and a second indication of at least one TRP associated with the m-TRP transmission.

In some example embodiments, the first indication is included in a sub-header of a medium access control control element for multi-transmission and reception point transmission, and the sub-header of the medium access control control element further comprises a logical channel identity corresponding to the multi-transmission and reception point transmission, and wherein the second indication is included in a payload of the medium access control control element.

In some example embodiments, the means for transmitting the first indication and the second indication comprises: means for in accordance with a determination that the target type is a coherent joint transmission, setting the first indication to a first value indicative of the coherent joint transmission; means for setting the second indication to a value indicative of a first transmission and reception point transmitting downlink control information for the multi-transmission and reception point transmission; and means for transmitting the medium access control control element comprising the first indication and the second indication to the first apparatus.

In some example embodiments, the payload of the medium access control control element further comprises a third indication. The means for transmit the first indication and the second indication comprises: means for in accordance with a determination that the target type is a non-coherent joint transmission, setting the first indication to a second value indicative of the non-coherent joint transmission; means for setting the second indication to a value indicative of at least one first transmission and reception point transmitting at least one downlink control information for the multi-transmission and reception point transmission; means for setting the third indication to a value indicative of a group of second transmission and reception points transmitting the multi-transmission and reception point transmission; and means for transmitting the medium access control control element comprising the first indication, the second indication and the third indication to the first apparatus.

In some example embodiments, the first indication is included in a field for a CORESET pool identity of a medium access control control element for transmission configuration indicator state, and the second indication is included in a field of a bandwidth part identity of the medium access control control element.

In some example embodiments, the means for transmitting the first indication and the second indication comprises: means for in accordance with a determination that the target type is a coherent joint transmission, setting the first indication to a first value indicative of the coherent joint transmission; means for setting the second indication to a value indicative of a first transmission and reception point transmitting downlink control information for the multi-transmission and reception point transmission; and means for transmitting the medium access control control element for transmission configuration indicator state comprising the first indication and the second indication to the first apparatus.

In some example embodiments, the means for transmitting the first indication and the second indication comprises: means for in accordance with a determination that the target type is a non-coherent joint transmission, setting the first indication to a second value indicative of the non-coherent joint transmission; means for setting the second indication to a value indicative of a group of second transmission and reception points transmitting the multi-transmission and reception point transmission; and means for transmitting the medium access control control element for transmission configuration indicator state comprising the first indication and the second indication to the first apparatus.

In some example embodiments, the second apparatus further comprises: means for transmitting, to the first apparatus, a radio resource control message indicating at least one first transmission and reception point transmitting at least one downlink control information for the non-coherent joint transmission.

In some example embodiments, the field of the bandwidth part identity comprises 2 bits, and a first value of the bandwidth part identity indicates the first one of the group of second transmission and reception points transmitting the multi-transmission and reception point transmission, a second value of the bandwidth part identity indicates the first two of the group of second transmission and reception points transmitting the multi-transmission and reception point transmission, a third value of the bandwidth part identity indicates the first three of the group of second transmission and reception points transmitting the multi-transmission and reception point transmission, a fourth value of the bandwidth part identity indicates the group of second transmission and reception points transmitting the multi-transmission and reception point transmission, and an order of the group of second transmission and reception points is based on a predefined rule associated with the group of second transmission and reception points.

In some example embodiments, the first apparatus comprises a terminal device, and a second apparatus comprises a network device.

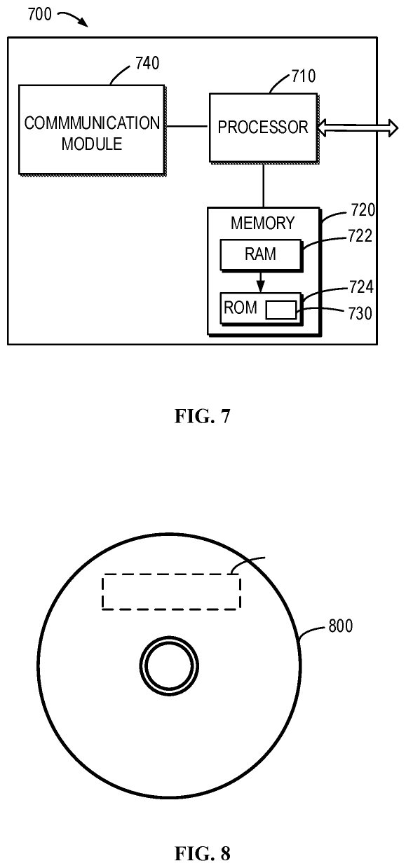

FIG. 7 is a simplified block diagram of a device 700 that is suitable for implementing embodiments of the present disclosure. The device 700 may be provided to implement the communication device, for example the first device 110 or the second device 120 as shown in FIG. 1. As shown, the device 700 includes one or more processors 710, one or more memories 720 coupled to the processor 710, and one or more transmitters and/or receivers (TX/RX) 740 (i.e., the communication module 740) coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2-6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIGS. 5 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory storing instructions that, when executed by the at least one processor, cause the first device at least to:
receive, from a second device, a first indication of a target type of a multi-transmission and reception point transmission to be scheduled in a target transmission occasion and a second indication of at least one transmission and reception point associated with the multi-transmission and reception point transmission; and
receive the multi-transmission and reception point transmission based at least in part on the first and second indications in the target transmission occasion.

2. The first device of claim 1, wherein the at least one memory storing instructions that, when executed by the at least one processor, cause the first device to receive the multi-transmission and reception point transmission by:
receiving, from the at least one multi-transmission and reception point as indicated by the second indication, the multi-transmission and reception point transmission according to the target type as indicated by the first indication.

3. The first device of claim 1, wherein the first indication is included in a sub-header of a medium access control control element for multi-transmission and reception point transmission, and the sub-header of the medium access control control element further comprises a logical channel identity corresponding to the multi-transmission and reception point transmission, and wherein the second indication is included in a payload of the medium access control control element and indicates at least one first transmission and reception point transmitting at least one downlink control information for the multi-transmission and reception point transmission.

4. The first device of claim 3, wherein the at least one memory storing instructions that, when executed by the at least one processor, cause the first device to receive the multi-transmission and reception point transmission by:
in accordance with a determination that the first indication is set to a first value indicative of a coherent joint transmission determining a first transmission and reception point based on a value of the second indication;
receiving, from the first transmission and reception point, downlink control information for the coherent joint transmission; and
receiving, based on the downlink control information and from a group of second transmission and reception points, a plurality of data transmissions corresponding to the coherent joint transmission.

5. The first device of claim 3, wherein the payload of the medium access control control element further comprises a third indication of a group of second transmission and reception points transmitting the multi-transmission and reception point transmission, and wherein the at least one memory storing instructions that, when executed by the at least one processor, cause the first device to receive the multi-transmission and reception point transmission by:
in accordance with a determination that the first indication is set to a second value indicative of a non-coherent joint transmission, determining the at least one first transmission and reception point based on a value of the second indication and the group of second transmission and reception points based on a value of the third indication;
receiving, from the at least one first transmission and reception point, at least one downlink control information for the non-coherent joint transmission; and
receiving, based on the at least one downlink control information and from the group of second transmission and reception points, a plurality of data transmissions corresponding to the non-coherent joint transmission.

6. The first device of claim 5, wherein the at least one memory storing instructions that, when executed by the at least one processor, further cause the first device to:
in accordance with a determination that the value of the second indication indicates a single first transmission and reception point, determine the multi-transmission and reception point transmission to be scheduled by a single downlink control information; and
in accordance with a determination that the value of the second indication indicates a plurality of first transmission and reception points, determine the multi-transmission and reception point transmission to be scheduled by multiple downlink control information.

7. The first device of claim 1, wherein the first indication is included in a field for a CORESET pool identity of a medium access control control element for transmission configuration indicator state, and the second indication is included in a field of a bandwidth part identity of the medium access control control element.

8. The first device of claim 7, wherein the at least one memory storing instructions that, when executed by the at least one processor, cause the first device to receive the multi-transmission and reception point transmission by:
in accordance with a determination that the first indication is set to a first value indicative of the coherent joint transmission, determining a first transmission and reception point transmitting downlink control information for the coherent joint transmission based on a value of the second indication;
receiving the downlink control information from the first transmission and reception point; and
receiving, based on the downlink control information and from a group of second transmission and reception points, a plurality of data transmissions corresponding to the coherent joint transmission.

9. The first device of claim 7, wherein the at least one memory storing instructions that, when executed by the at least one processor, cause the first device to receive the multi-transmission and reception point transmission by:
in accordance with a determination that the first indication is set to a second value indicative of the non-coherent joint transmission, determining at least one of a group of second transmission and reception points transmitting the multi-transmission and reception point transmission based on a value of the second indication;
receiving, from the second device, a radio resource control message indicating at least one first transmission and reception point transmitting at least one downlink control information for the non-coherent joint transmission;
receiving the at least one downlink control information from the at least one first transmission and reception point; and
receiving, based on the at least one downlink control information and from the at least one of the group of second transmission and reception points, a plurality of data transmissions corresponding to the non-coherent joint transmission.

10. The first device of claim 9, wherein the radio resource control message indicates the non-coherent joint transmission to be scheduled by a single downlink control information or multiple downlink control information.

11. The first device of claim 9, wherein the field of the bandwidth part identity comprises 2 bits, and a first value of the bandwidth part identity indicates the first one of the group of second transmission and reception points transmitting the multi-transmission and reception point transmission, a second value of the bandwidth part identity indicates the first two of the group of second transmission and reception points transmitting the multi-transmission and reception point transmission, a third value of the bandwidth part identity indicates the first three of the group of second transmission and reception points transmitting the multi-transmission and reception point transmission, a fourth value of the bandwidth part identity indicates the group of second transmission and reception points transmitting the multi-transmission and reception point transmission, and an order of the group of second transmission and reception points is based on a predefined rule associated with the group of second transmission and reception points.

12. The first device of claim 1, wherein the first device comprises a terminal device, and the second device comprises a network device.

13. A second device, comprising:
at least one processor; and
at least one memory storing instructions that, when executed by the at least one processor, cause the second device at least to:
transmit, to a first device, a first indication of a target type of a multi-transmission and reception point transmission to be scheduled in a target transmission occasion and a second indication of at least one transmission and reception point associated with the multi-transmission and reception point transmission.

14. The second device of claim 13, wherein the first indication is included in a sub-header of a medium access control control element for multi-transmission and reception point transmission, and the sub-header of the medium access control control element further comprises a logical channel identity corresponding to the multi-transmission and reception point transmission, and wherein the second indication is included in a payload of the medium access control control element.

15. The second device of claim 14, wherein the at least one memory storing instructions that, when executed by the at least one processor, cause the second device to transmit the first indication and the second indication by:
in accordance with a determination that the target type is a coherent joint transmission, setting the first indication to a first value indicative of the coherent joint transmission;
setting the second indication to a value indicative of a first transmission and reception point transmitting downlink control information for the multi-transmission and reception point transmission; and
transmitting the medium access control control element comprising the first indication and the second indication to the first device.

16. The second device of claim 14, wherein the payload of the medium access control control element further comprises a third indication, and
wherein the at least one memory storing instructions that, when executed by the at least one processor, cause the second device to transmit the first indication and the second indication by:
in accordance with a determination that the target type is a non-coherent joint transmission, setting the first indication to a second value indicative of the non-coherent joint transmission;
setting the second indication to a value indicative of at least one first transmission and reception point transmitting at least one downlink control information for the multi-transmission and reception point transmission;
setting the third indication to a value indicative of a group of second transmission and reception points transmitting the multi-transmission and reception point transmission; and
transmitting the medium access control control element comprising the first indication, the second indication and the third indication to the first device.

17. The second device of claim 13, wherein the first indication is included in a field for a CORESET pool identity of a medium access control control element for transmission configuration indicator state, and the second indication is included in a field of a bandwidth part identity of the medium access control control element.

18. The second device of claim 17, wherein the at least one memory storing instructions that, when executed by the at least one processor, cause the second device to transmit the first indication and the second indication by:
in accordance with a determination that the target type is a coherent joint transmission, setting the first indication to a first value indicative of the coherent joint transmission;
setting the second indication to a value indicative of a first transmission and reception point transmitting downlink control information for the multi-transmission and reception point transmission; and
transmitting the medium access control control element for transmission configuration indicator state comprising the first indication and the second indication to the first device.

19. The second device of claim 17, wherein the at least one memory storing instructions that, when executed by the at least one processor, cause the second device to transmit the first indication and the second indication by:
in accordance with a determination that the target type is a non-coherent joint transmission, setting the first indication to a second value indicative of the non-coherent joint transmission;
setting the second indication to a value indicative of a group of second transmission and reception points transmitting the multi-transmission and reception point transmission; and
transmitting the medium access control control element for transmission configuration indicator state comprising the first indication and the second indication to the first device.

20. (canceled)

21. (canceled)

22. (canceled)

23. A method comprising:
receiving, at a first device and from a second device, a first indication of a target type of a multi-transmission and reception point transmission to be scheduled in a target transmission occasion and a second indication of at least one transmission and reception point associated with the multi-transmission and reception point transmission; and
receiving the multi-transmission and reception point transmission based at least in part on the first and second indications in the target transmission occasion.

24. (canceled)

25. (canceled)

26. (canceled)

27. (canceled)
